(19) United States
(12) Patent Application Publication
(10) Pub. No.: US 2023/0270612 A1
(43) Pub. Date: Aug. 31, 2023

(54) BODY BALANCE CORRECTING APPARATUS AND BODY BALANCE CORRECTING METHOD

(71) Applicant: Masamichi KAMEI, Tokyo (JP)

(72) Inventor: Masamichi KAMEI, Tokyo (JP)

(21) Appl. No.: 18/005,410

(22) PCT Filed: Jun. 23, 2021
(86) PCT No.: PCT/JP2021/023773

§ 371 Date: Jan. 13, 2023

(30) Foreign Application Priority Data
Jul. 30, 2020 (JP) 2020-128883
Apr. 5, 2021 (JP) 2021-064069

(51) Int. Cl. A61H 1/00

(52) U.S. Cl. CPC A61H 1/003; A61H 1/005; A61H 2201/0146; A61H 2203/0456; A61H 2201/5005

(57) ABSTRACT

This body balance correcting apparatus is capable of improving blood circulation, skeletal balance and the like from the inside of the body by oscillating the body of a user, and includes an oscillation panel which supports the user in a recumbent position, a support device which supports the oscillation panel so as to enable the oscillation panel to oscillate in the in-plane direction, a drive device which oscillates the oscillation panel in the axial direction of the body of a user, and a controller which controls the acceleration and deceleration of the oscillation by the drive device. The oscillation panel can be adjusted to oscillate at an amplitude in the horizontal direction with respect to the support device in a range of about 0 to 6 cm and within 15 cm and with a cycle in a range of about 0.5 to 2.0 seconds, and by adjusting the acceleration and deceleration of the oscillation of the oscillation panel by the control order from the controller, blood circulation and skeletal balance can be improved from the inside of the body of the user.

### TECHNICAL FIELD

This invention relates to a body balance correcting apparatus and a body balance correcting method with which blood circulation, skeletal balance and the like can be ameliorated over a wide range of the whole body of a user while the user is lying in a recumbent position on this apparatus.

### BACKGROUND ARTS

In regards to an apparatus for amelioration of blood circulation of the human body, various types of massaging apparatuses such as massaging chairs and foot massagers have been heretofore developed and are now available on the market. Meanwhile, traction type correcting instruments, corsets and supporters are known as an instrument for correction of skeletal balance.

As one mattress type massaging apparatus, a patent document 1 below discloses a massaging apparatus having a long flat-shaped base body, wherein a pair of guide rails are placed on the opposite sides of the base body in the width direction, and a drive device with a motor as a drive source and a pillow base are respectively arranged on the opposite sides of the base body in the longitudinal direction. The guide rail is provided with a transmission belt reciprocated by the drive device and a moving body having a rotatable massaging roller, and the moving body is connected to the transmission belt. When the transmission belt is reciprocated by the drive device, reciprocation of the moving body is also performed in conjunction therewith, and consequently, a user lying face up on the moving body is able to receive a massage with the massaging roller of the moving body in the reciprocating motion.

Also, in relation to the same type of massaging apparatus, a patent document 2 below discloses a massaging apparatus comprising a mattress having a cushion material disposed on the lower side of the apparatus, and a massaging roller provided on the mattress, wherein the massaging apparatus is provided with a band body for pressing the foot of a user toward the massaging roller, and fitting of the band body is performed using a hook-and-loop fastener.

Further, in relation to the same type of massaging apparatus, a patent document 3 below discloses a massaging apparatus capable of massaging the back of a user with a massaging roller and also giving a massage to a leg part and a neck part of the user so as to take off the stiffness of these parts, instead of a massage by merely pressing with the massaging roller.

In addition to the above, with the object of providing a lightweight and thin massaging instrument to meet the needs that a user such as an aged user wants to be able to use a massaging instrument while in bed, a patent document 4 below discloses a massaging instrument comprising a bottom plate, a long plate-shaped vibration plate being slidable on an upper surface of the bottom plate, a drive part, a support part for supporting the drive part with the bottom plate as the base in a position above a vibration plate portion on one longitudinal end side within an upper surface of the vibration plate, a drive force transmission part for transmitting a drive force from the drive part to the vibration plate through a vibration plate portion right beneath the drive part within the upper surface of the vibration plate to vibrate the vibration plate while sliding the vibration plate on an upper surface of the bottom plate, and a suspending part for suspending the vibration plate from the support part so as to enable the vibration plate to vibrate.

As one reciprocating base which is to move a subject reciprocally in the head and foot directions, a patent document 5 below discloses a base assembly having a movable base capable of being operated by an oscillatory motion to move the subject laid on the base in the head and foot directions together with the base. This base assembly takes advantage of speed, oscillation frequency and deformation in symmetry of the oscillatory motion of the base, and is considered to be applicable to sleep inducement, sleep apnea prevention, awakening effect promotion, amelioration of patients from restless legs syndromes and from painful walking and tiptoe numbing syndromes, non-invasive motional ventilation, non-invasive vibratory ventilation, non-invasive cardio-pulmonary functional recovery, non-invasive counter-pulsation, increase in cardiac stroke volume, cardio-pulmonary functional support for non-invasive cardio-pulmonary bypassing, chemical mediator release and stimulation of intestinal movement, for instance.

As one oscillatory mattress capable of downsizing of an oscillation mechanism and being easy to be moved and installed, a patent document 6 below discloses an oscillatory mattress comprising a mattress body on which a user lies, an oscillation part for reciprocating the mattress body, and a mattress cover for enclosing both the mattress body and the oscillation part, wherein the oscillation part is equipped with a body support member for supporting the mattress body, an oscillation holding member for holding reciprocation of the body support member, and a motor as a drive part for reciprocating the body support member.

As one bed capable of being used for multiple purposes such as restful sleep and health promotion, for instance, a patent document 7 below discloses a bed which supports a human body support plate in a position above a bed body part so as to enable the support plate to reciprocate in the horizontal direction by means of a drive mechanism, wherein a buffering means for relieving the impact in the change of direction is provided between the bed body part and the support plate.

In relation to modeling of blood pressure fluctuation which appears during deceleration of an ambulance, a non-patent document 1 below states that “Fluctuation in blood pressure of a subject occurs when acceleration for long duration acts on the subject, just as the event that the ambulance is braked suddenly. As one feature thereof, there is a tendency toward the rise in blood pressure in each part of the human body in the direction opposite to the direction in which the acceleration acts on the subject. If the human body is likened to a tube filled with a body fluid, such tendency can be the same phenomenon as an internal pressure change caused by the acceleration acting on the tube in the axial direction. Further, there can be blood pressure fluctuation caused by the forcible circulation of venous blood due to the acceleration as well”.

### PRIOR ART DOCUMENTS

### Patent Documents

Patent document 1: Japanese Utility Model Publication No. Hei04-20434

Patent document 2: Japanese Patent Publication No. 2866306

Patent document 3: Japanese Patent Publication No. 4576110

Patent document 4: Japanese Patent Publication No. 6426452

Patent document 5: International Publication No. 98/39996

Patent document 6: Japanese Unexamined Patent Application Publication No. 2017-051552

Patent document 7: Japanese Unexamined Patent Application Publication No. 2003-052488

### Non-Patent Document

Non-patent document 1: “Modeling of blood pressure fluctuation appearing during deceleration of ambulance”, by Koichi SAGAWA et al. The journal of Medical Electronics and Biomedical Technology 31 (2), pp. 35 to 42, June, 1993

### SUMMARY OF THE INVENTION

### Problems to be Solved by the Invention

The mattress type massaging apparatus as disclosed in each of the patent documents 1 to 3 is structured such that the massaging roller is supposed to directly bear a substantial proportion of the weight of the user during application of a pressing force by the massaging roller to the user in a recumbent position, and accordingly, it is necessary for not only the massaging roller and its axis diameter part but also the whole drive mechanism to have a sturdy structure.

For that reason, there is a problem that the above massaging apparatus shall lead to a considerable increase in weight thereof as a whole, and is thus inconvenient to handle. Besides, because of the fact that a relatively large force acts on the user from the massaging roller, there is a risk that local inflammation will appear on a body part of the user to which a massage is given, or otherwise, the user, particularly, the aged user will suffer a fracture in that body part, depending on user's use condition.

The massaging instrument as disclosed in the patent document 4 is a massaging instrument having been developed as a lightweight and thin massaging instrument that the user such as the aged user is able to use while in bed, in which case, however, this massaging instrument shall transmit rotation of the motor as the drive part to the vibration plate through a crank mechanism to vibrate the vibration plate while sliding the vibration plate on the upper surface of the bottom plate, and accordingly, any high massage effect cannot be expected.

The reciprocating base as disclosed in the patent document 5 is to be subjected to oscillation for the purpose of relief, medical cares or emergency measures of the symptoms of the subject or in-patient who undergoes monitoring in a hospital, for instance, in response to the symptoms thereof.

Namely, this reciprocating base is an invention relating to one technology using high-frequency oscillation at small amplitude for the sake of medical cares in the hospital, just as the specification thereof has stated that “oscillation with a frequency in the range of 30 to 40 hertz is applied to the base in order to decrease the sensitivity of short breath of the subject”, “for instance, the body of a dog in a state of being anesthetized by an anesthetic means is laid in a recumbent position such that one's chest part is placed on an oscillation plate which oscillates with an oscillation frequency in the range of 15 to 30 hertz and at an amplitude in the upward and downward directions in the range of 2 to 4 mm”, “in regards to a respiration system of the subject on the base as a ventilation source of the subject, it is possible to be operated to oscillate at an amplitude in the range of about 1.5 to 2.5 cm and with a resonance frequency in the range of 3 to 12 hertz or in its proximity”, and “when the oscillation of the reciprocating base is performed with the resonance frequency in the range of 3 to 12 hertz, this reciprocating base is supposed to provide cardio-pulmonary functional support functions or cardio functional support functions for the purpose of 1) cardio-pulmonary functional recovery, 2) counter-pulsation, 3) single cardiac stroke volume and 4) non-invasive cardio-pulmonary bypassing”.

The oscillatory mattress as disclosed in the patent document 6 constitutes a structure in which a mattress body part on which the user lies is configured as the oscillation part for reciprocating the mattress body part, in which case, however, the mattress itself is assumed to be a soft mattress enough to be suitable for sleep inducement, and accordingly, can be a mattress which is to impart substantially gentle oscillation to the user.

The bed as disclosed in the patent document 7 is also an invention relating to the oscillatory bed, in which case, however, this is to prevent an excessive force from acting on the body of the user during oscillation in such a manner as to provide the buffering means between the bed body part and the support plate to relieve the impact in the change of direction.

The present invention is aimed at solving the above problems in the prior arts, and hence, is to provide a body balance correcting apparatus and a body balance correcting method with which blood circulation, skeletal balance and the like can be ameliorated from the inside of the body of a user by allowing a great oscillation force to act on the whole body of the user including one's skeletal, muscular and blood circulatory systems in such a manner as to accelerate and decelerate oscillation while subjecting the body of the user to oscillation, instead of by directly applying a force from a roller and/or an oscillation panel of a conventional type of massaging apparatus to the human body in the form of a massaging and/or pressing or stimulation-imparting force.

### Means for Solving the Problems

A body balance correcting apparatus according to the present invention comprises an oscillation panel for supporting a user in a recumbent position, a support device for supporting the oscillation panel so as to enable the oscillation panel to oscillate in the in-plane direction, a drive means for oscillating the oscillation panel with respect to the support device, and an oscillation control means for controlling the oscillation caused by the drive means, wherein the oscillation control means is equipped with an amplitude adjustment means capable of adjusting an amplitude A of the oscillation of the oscillation panel in the horizontal direction with respect to the support device at least in a range of 0 to 6 cm and within 15 cm, a cycle adjustment means capable of adjusting a cycle T of the oscillation of the oscillation panel at least in a range of 0.5 to 2.0 seconds, and an acceleration adjustment means for making adjustment of acceleration and deceleration of the oscillation of the oscillation panel, and wherein the amplitude, cycle and repetition between acceleration and deceleration of the oscillation of the oscillation panel are controlled by the oscillation control means, thereby allowing a force equivalent to the acceleration from the drive means to act on the whole body of the user including one's skeletal, muscular and blood circulatory systems.

In principle, the body balance correcting apparatus of the present invention makes use of an energy generated by a drive source as a force for oscillation of the body of the user through the oscillation panel, and particularly performs control of repetition between acceleration and deceleration of the oscillation to allow a force equivalent to the acceleration at that time to act on the body of the user, thereby resulting in enabling amelioration of blood circulation, correction of skeleton and joint positions, and consequently, correction of body balance over a wide range of the body of the user to be achieved by an interaction caused by a difference in constitution and/or form of the body tissues between the internal tissues of the whole body of the user including one's skeletal, muscular and blood circulatory systems, unlike a conventional type of massaging apparatus which is to directly apply the force to the human body in the form of a massaging and/or pressing or stimulation-imparting force with an energy generated by the drive source.

Namely, the body balance correcting apparatus of the present invention shall allow the direction of even a force acting on blood flowing through blood vessels to be changed alternately in accordance with the direction and magnitude of acceleration during repetitive reciprocation of the oscillation panel, because the user is laid in a recumbent position on the oscillation panel. For instance, a massaging chair or like massaging apparatus can cause deprivation of a blood flow to the head, whereas a massage given to the user in the recumbent position provides the advantage of hardly causing a biased blood flow.

By repeating acceleration and deceleration of the oscillation, preferably, those inclusive of rapid acceleration and rapid deceleration thereof during the time that the body of the user is being subjected to oscillation together with the oscillation panel, the blood circulation comes to be ameliorated even though there is a frictional force being generated between an inside wall of the blood vessel and the blood flow.

Likewise, in regards to the tissues of the skeletal and muscular systems and the like, by repeating acceleration and deceleration of the oscillation, preferably, those inclusive of rapid acceleration and rapid deceleration thereof during the time that the body of the user is being subjected to oscillation in a situation where the user is relaxed with one's body stretched in the recumbent position, a mutually massaging force shall be imparted, and consequently, an effect of body balance correction inclusive of skeletal correction is obtained.

In terms of the rapid acceleration and rapid deceleration of the oscillation, the acceleration can be adjusted in a range of about −0.5 to +0.5G, for instance. In actual control of the acceleration, the acceleration shall be adjusted to obtain a maximum acceleration in a range of about 0.1 to 0.4G so as to ensure that an instantaneous impact shall be imparted in the above range of the amplitude A and in that of the cycle T, thereby resulting in allowing the effect of body balance correction to be enhanced. In this case, a combination of the rapid acceleration with the rapid deceleration may be preferably imparted in a pulse form at intervals.

In regards to the amplitude adjustment means, limitation is imposed in that the amplitude A (half amplitude) of the oscillation of the oscillation panel in the horizontal direction with respect to the support device can be adjusted at least in the range of 0 to 6 cm and within 15 cm. This is because an appropriate range for the amplitude to be controlled after start of the oscillation of the oscillation panel can be from about 2 to 6 cm in consideration of operational control of the body balance correcting apparatus of the present invention as described later, in other words, this is to guarantee that control of the amplitude at least in that range is executable, but not mean that any amplitude possible to be controlled in a range wider than the above should be excluded. However, control of the amplitude in a range of exceeding 15 cm in terms of half amplitude (30 cm in terms of double amplitude) is considered to be impractical, and accordingly, the amplitude shall be confined to within 15 cm.

In regards to the cycle adjustment means, limitation is imposed in that the cycle T of the oscillation of the oscillation panel can be adjusted at least in the range of 0.5 to 2.0 seconds. This is because an appropriate range for the cycle to be controlled after start of the oscillation of the oscillation panel can be from about 0.8 to 1.5 seconds in consideration of operational control of the body balance correcting apparatus of the present invention as described later, in other words, this is to guarantee that control of the cycle at least in that range is executable.

It is to be noted that the cycle of the oscillation in the range of 0.5 to 2.0 seconds is limited only for a cycle with which the body of the user is subjected to oscillation, and accordingly, oscillation with the cycle in that range is completely different in action from the oscillation caused by a high-frequency vibrator as one massaging apparatus.

The oscillation panel can constitute a structure in which the oscillation panel is supported to the support device through a slide surface formed using a low friction material. Namely, the presence of the slide surface formed on a contact surface between the oscillation panel and the support device by using the low friction material such as fluorocarbon resin, for instance, enables the oscillation panel to oscillate with a smaller drive force.

Alternatively, it may be possible also for the oscillation panel to constitute a structure in which the oscillation panel is supported to the support device through a plurality of rollers or ball rollers to reduce friction between the oscillation panel and the support device.

A linear servo motor and/or a linear drive device using a ball screw is suitable for the drive means which is to oscillate the oscillation panel with respect to the support device. These types of drive means can make a drive part structure compact and besides, allows acceleration and deceleration of the oscillation to be smoothly imparted by a control means using a microcomputer, for instance.

The control means may preferably have not only a function of controlling the speed and/or amplitude of the oscillation but also a function of storing a large number of patterns of acceleration and deceleration of the oscillation inclusive of the rapid acceleration and rapid deceleration thereof to permit selection of the pattern in accordance with a situation of the user.

While the direction of oscillation of the oscillation panel is basically the axial direction of the body of the user, it is to be noted that it may be possible also for the oscillation panel to constitute a mechanism which is to provide oscillation in the direction perpendicular to or more obliquely angled to the axial direction of the body of the user.

Meanwhile, when the body balance correcting apparatus of the present invention operates to perform control of acceleration and deceleration of the oscillation by the control means in a gentle pattern, as a secondary function thereof, it becomes possible to relax the user and also to give a sleep induction effect to the user.

Further, various restraint means may be used to suppress the movement of the body of the user during oscillation. The restraint means may be of a type capable of suppressing the movement of the body of the user to a certain extent without the need to be completely fixed to the user.

As the restraint means, use can be made of a belt-like restraint tool, for instance. In this case, it is convenient to use a removable type restraint tool capable of being removably attached using a hook-and-loop fastener. Other types of restraint tools such as string-like and ring-like restraint tools are available as well.

The restraint means is not limited in use by being installed in a position between the body of the user and the oscillation panel, but can be used also by being connected to a support device part of the body balance correcting apparatus, or to any instrument separate therefrom, or to any fixture close thereto. By attaching one end of the restraint tool to an ankle of the user, for instance, a cyclic load shall additionally act on the ankle in parallel with the oscillation of the oscillation panel, and accordingly, the body balance correction can be expected as well as the massage effect.

Alternatively, a certain degree of effect similar to the oscillation of the oscillation panel can be obtained merely by pulling one end of the restraint tool repeatedly by a person other than the user, with the other end thereof attached to the ankle of the user.

Further, the support device of the body balance correcting apparatus can be equipped with an upper load measurement means for making measurement of an upper load inclusive of a mass of the oscillation panel. In this case, it is possible not only to measure the weight of the user by a difference between loads before and after the user lies thereon but also to adjust or correct the acceleration applied from the drive means to the user in accordance with the weight of the user as well as a force or impact imparted to the user due to that acceleration.

Meanwhile, it may be possible also for the body balance correcting apparatus of the present invention to be configured such that the oscillation panel is divided into a plurality of oscillation panel units as seen in a plane, and that the drive means is provided every oscillation panel unit to oscillate each respective oscillation panel unit with respect to the support device so as to enable the oscillation of the oscillation panel units by the respective drive means to be individually controlled.

For the oscillation panel in the form of being divided into two, namely right and left oscillation panel units in the body direction of the user, for instance, when the directions of oscillation of the respective oscillation panel units are controlled to be reversed to each other, a massage action can be also imparted in the form of application of periodic twist between a right half and a left half of the body of the user.

Alternatively, for the oscillation panel in the form of being divided into two, namely front and rear oscillation panel units in the body direction of the user, when the directions of oscillation of the respective oscillation panel units are controlled to be reversed to each other, the massage action can be also imparted in the form of application of periodic twist between an upper half and a lower half of the body of the user.

Further, the oscillation panel may be divided into four, namely the front, rear, right and left oscillation panel units to control the directions of the oscillation of the respective oscillation panel units. In this case, when the left-sided front and rear oscillation panel units are subjected to oscillation in synchronization with each other in the longitudinal direction, while the right-sided front and rear oscillation panel units are subjected to oscillation in synchronization with each other in the direction opposite to the left-sided two oscillation panel units, the same motion as the oscillation panel in the form of being divided into the right and left oscillation panel units can be obtained.

Likewise, when the front-sided right and left oscillation panel units are subjected to oscillation in synchronization with each other in the horizontal direction, while the rear-sided right and left oscillation panel units are subjected to oscillation in synchronization with each other in the direction opposite to the front-sided two oscillation panel units, the same motion as the oscillation panel in the form of being divided into the front and rear oscillation panel units can be obtained.

Further, the four pieces of oscillation panel units resulting from division of the oscillation panel into the front, rear, right and left oscillation panel units can be controlled so as to make these oscillation panel units move independently of each other, as well.

A body balance correcting method of the present invention is characterized by using a body balance correcting apparatus comprising an oscillation panel for supporting a user in a recumbent position, a support device for supporting the oscillation panel so as to enable the oscillation panel to oscillate in the in-plane direction, a drive means for oscillating the oscillation panel with respect to the support device, and an oscillation control means for controlling oscillation caused by the drive means, the oscillation control means being equipped with an amplitude adjustment means capable of adjusting an amplitude A of the oscillation of the oscillation panel in the horizontal direction with respect to the support device at least in a range of 0 to 6 cm and within 15 cm, a cycle adjustment means capable of adjusting a cycle T of the oscillation of the oscillation panel at least in a range of 0.5 to 2.0 seconds, and an acceleration adjustment means for making adjustment of acceleration and deceleration of the oscillation of the oscillation panel, wherein the amplitude, cycle and repetition between acceleration and deceleration of the oscillation of the oscillation panel are controlled by the oscillation control means, thereby allowing a force equivalent to the acceleration from the drive means to act on the whole body of the user including one's skeletal, muscular and blood circulatory systems.

The appropriate range for the amplitude to be controlled after start of the oscillation of the oscillation panel by the oscillation control means can be from about 2 to 6 cm, and the appropriate range for the cycle to be controlled after start of the oscillation of the oscillation panel by the oscillation control means can be from about 0.8 to 1.5 seconds. Application of the acceleration and deceleration of the oscillation or that of the rapid acceleration and rapid deceleration thereof in the above amplitude range and in the above cycle range allows a force or impact equivalent to the acceleration to be imparted to the whole body of the user, thereby resulting in relaxing the user mentally, while enabling amelioration of blood circulation, correction of skeleton and joint positions and consequently, correction of body balance over the wide range of the body of the user to be achieved by the interaction caused by the difference in constitution and/or form of the body tissues between the internal tissues of the whole body of the user including one's skeletal, muscular and blood circulatory systems.

A body balance correcting apparatus according to another mode of the present invention comprises an oscillation panel for supporting a user in a recumbent position, a support device for supporting the oscillation panel so as to enable the oscillation panel to oscillate in the in-plane direction, a drive means for oscillating the oscillation panel with respect to the support device, and an oscillation control means for controlling oscillation caused by the drive means, the oscillation panel being divided into a plurality of oscillation panel units as seen from a plane, the drive means being provided every oscillation panel unit to oscillate each respective oscillation panel unit with respect to the support device, wherein the oscillation control means is equipped with an amplitude adjustment means capable of adjusting an amplitude A of the oscillation of each respective oscillation panel unit in the horizontal direction with respect to the support device, a cycle adjustment means capable of adjusting a cycle T of the oscillation of each respective oscillation panel unit, and an acceleration adjustment means for making adjustment of acceleration and deceleration of the oscillation of each respective oscillation panel unit, and wherein the amplitude, cycle and repetition between acceleration and deceleration of the oscillation of each respective oscillation panel unit are controlled by the oscillation control means, thereby allowing a force equivalent to the acceleration from the drive means corresponding to each respective oscillation panel unit to act on the whole body of the user including one's skeletal, muscular and blood circulatory systems.

A body balance correcting method according to another mode of the present invention is characterized by using a body balance correcting apparatus comprising an oscillation panel for supporting a user in a recumbent position, a support device for supporting the oscillation panel so as to enable the oscillation panel to oscillate in the in-plane direction, a drive means for oscillating the oscillation panel with respect to the support device, and an oscillation control means for controlling oscillation caused by the drive means, the oscillation panel being divided into a plurality of oscillation panel units as seen from a plane, the drive means being provided every oscillation panel unit to oscillate each respective oscillation panel unit with respect to the support device, the oscillation control means being equipped with an amplitude adjustment means capable of adjusting an amplitude A of the oscillation of each respective oscillation panel unit in the horizontal direction with respect to the support device, a cycle adjustment means capable of adjusting a cycle T of the oscillation of each respective oscillation panel unit, and an acceleration adjustment means for making adjustment of acceleration and deceleration of the oscillation of each respective oscillation panel unit, wherein the amplitude, cycle and repetition between acceleration and deceleration of the oscillation of each respective oscillation panel unit are controlled by the oscillation control means, thereby allowing a force equivalent to the acceleration from the drive means corresponding to each respective oscillation panel unit to act on the whole body of the user including one's skeletal, muscular and blood circulatory systems.

In regards to the above another mode of the present invention, for the oscillation panel in the form of being divided into two, namely, the right and left oscillation panel units in the body direction of the user, for instance, when the directions of the oscillation of the respective oscillation panel units are controlled to be reversed to each other, the massage action can be also imparted in the form of application of periodic twist between the right half and the left half of the body of the user.

Alternatively, for the oscillation panel in the form of being divided into two, namely the front and rear oscillation panel units in the body direction of the user, the directions of the oscillation of the respective oscillation panel units are controlled to be reversed to each other, the massage action can be also imparted in the form of application of periodic twist between the upper half and the lower half of the body of the user.

Further, the oscillation panel may be divided into four, namely the front, rear, right and left oscillation panel units to control the directions of the oscillation of the respective oscillation panel units. In this case, when the left-sided front and rear oscillation panel units are subjected to oscillation in synchronization with each other in the longitudinal direction, while the right-sided front and rear oscillation panel units are subjected to oscillation in synchronization with each other in the direction opposite to the left-sided two oscillation panel units, the same motion as the oscillation panel in the form of being divided into the right and left oscillation panel units can be obtained.

Likewise, when the front-sided right and left oscillation panel units are subjected to oscillation in synchronization with each other in the horizontal direction, while the rear-sided right and left oscillation panel units are subjected to oscillation in synchronization with each other in the direction opposite to the front-sided two oscillation panel units, the same motion as the oscillation panel in the form of being divided into the front and rear oscillation panel units can be obtained.

Further, the four pieces of oscillation panel units resulting from division of the oscillation panel into the front, rear, right and left oscillation panel units can be controlled so as to make these oscillation panel units move independently of each other, as well.

In regards to the individual oscillation panel units, it is preferable that each respective oscillation panel unit should be controlled to oscillate at an amplitude in a range of about 0 to 6 cm and with a cycle in a range of about 0 to 1.5 seconds, thereby resulting in enabling amelioration of blood circulation, correction of skeleton and joint positions and consequently, correction of body balance over the wide range of the body of the user to be achieved by the interaction caused by the difference in constitution and/or form of the body tissues between the internal tissues of the whole body of the user including one's skeletal, muscular and blood circulatory systems, as well as giving various massage effects to the user in response to the motion of each individual oscillation panel unit.

### Effects of the Invention

In principle, the body balance correcting apparatus of the present invention makes use of an energy generated by the drive source as a force for oscillation of the body of the user through the oscillation panel, and allows for application of large acceleration during acceleration and deceleration of the oscillation, particularly, during rapid acceleration and rapid deceleration thereof, thereby resulting in enabling amelioration of blood circulation, correction of skeleton and joint positions and consequently, correction of body balance over the wide range of the body of the user to be achieved by the interaction caused by the difference in constitution and/or form of the body tissues between the internal tissues of the whole body of the user including one's skeletal, muscular and blood circulatory systems, unlike a conventional type of massaging apparatus which is to directly apply a force to the human body in the form of a massaging and/or pressing or stimulation-imparting force with an energy generated by the drive source.

Namely, the body balance correcting apparatus of the present invention shall allow the direction of even a force acting on a blood flowing through blood vessels to be changed alternately during repetitive reciprocation of the oscillation panel, because the user is laid in the recumbent position on the oscillation panel. For instance, a massaging chair or like massaging apparatus can cause deprivation of a blood flow to the head, whereas a massage given to the user in the recumbent position provides the advantage of hardly causing a biased blood flow.

Likewise, in regards to the tissues of the skeletal and muscular systems and the like, acceleration and deceleration of the oscillation are repeated so that a mutually massaging force shall be imparted during the time that the body of the user is being subjected to oscillation in a situation where the user is relaxed with one's body stretched in the recumbent position, and accordingly, an effect of body balance correction inclusive of the skeletal correction can be obtained.

When the acceleration and deceleration of the oscillation are repeated during the time that the body of the user is being subjected to oscillation together with the oscillation panel by the drive means, there is a frictional resistance force being imparted even in the position of contact between the oscillation panel and the body part of the user so that the user may have a sense of inertia force, in which case, however, the frictional resistance force in the position of contact therebetween at that time is allowed to act as a pressing force against the body part of the user, and accordingly, the massage effect can be obtained as well.

When the user wants to get the massage effect on one's specific body part, it is possible for the user to obtain the massage effect with respect to one's specific body part by taking a posture in which the user presses one's specific body part against the oscillation panel while in the recumbent position, or alternatively, by using an exclusive pad and the like, as needed.

While it is said that long-time sitting on the chair will bring about some strain in each part of the body, and consequently, lead to shoulder or neck stiffness and headache, for instance, the body balance correcting apparatus of the present invention enables these symptoms to be ameliorated, because of the fact that amelioration of skeletal balance, blood circulation and flow of lymph is achieved by repeatedly putting everyday use of this body balance correcting apparatus into practice even just the user merely lies on one's back thereon.

The body balance correcting apparatus of the present invention offers great advantage of providing a health promotion effect in an effective way and in safety particularly for the aged user whose ability to move is lowered and whose bones become brittle, because of the fact that there is no possibility of any accidents like those caused by a conventional type of massaging apparatus which is to apply a pressing force to the surface of the body of the user, and of the fact that the amelioration of blood circulation, flow of lymph and body balance can be achieved without the need for the user to move one's body by oneself.

Moreover, the body balance correcting apparatus of the present invention is effective in increasing also the flexibility of the body of the user as required for the user when doing muscle training after the body balance is ameliorated, and as a result, it becomes possible for the user to lead one's healthier life.

Namely, the body balance correcting apparatus of the present invention is believed to be effective for every person irrespective of age and gender as described the above, and it is thus being expected that there is an effect that use of this body balance correcting apparatus will lead to longevity of the user by allowing the user to have a tranquil life with one's body balance ameliorated as well as with one's mind relaxed enough to improve a vital energy.

### BRIEF DESCRIPTION OF THE DRAWINGS

FIG. 1 is an explanatory view of a force generated inside the body of a user with a body balance correcting apparatus of the present invention, FIG. 1(a) being a cross-sectional view showing the direction of the force generated inside the body when an oscillation panel is accelerated in the left direction in FIG. 1(a), FIG. 1(b) being a plan view corresponding to FIG. 1(a), FIG. 1(c) being a cross-sectional view showing the direction of the force generated inside the body when the oscillation panel is accelerated in the right direction in FIG. 1(c), and FIG. 1(d) being a plan view corresponding to FIG. 1(c).

FIG. 2 is an explanatory view of a force applied to the body of the user through the oscillation panel with the body balance correcting apparatus of the present invention, FIG. 2(a) being a cross-sectional view showing the direction of the force applied to the body through the oscillation panel at the moment that the oscillation panel is decelerated on the left side in FIG. 2(a) so that the accelerating direction is reversed, and FIG. 2(b) being a cross-sectional view showing one instance of the direction of the force applied to the body through the oscillation panel at the moment that the oscillation panel is decelerated on the right side in FIG. 2(a) so that the accelerating direction is reversed.

FIG. 3 is a perspective view showing the direction of oscillation of the oscillation panel with respect to a support device in the body balance correcting apparatus of the present invention.

FIG. 4 is an explanatory view planarly showing the oscillation panel in the form of being divided into two, namely right and left oscillation panel units in the body direction of the user, as another embodiment of the body balance correcting apparatus of the present invention.

FIG. 5 is an explanatory view planarly showing the oscillation panel in the form of being divided into two, namely front and rear oscillation panel units in the body direction of the user, as still another embodiment of the body balance correcting apparatus of the present invention.

FIG. 6 is an explanatory view planarly showing the oscillating panel in the form of being divided into four, namely the front, rear, right and left oscillation panel units, as still more another embodiment of the body balance correcting apparatus of the present invention.

### MODE FOR EMBODYING THE INVENTION

Hereinafter will be described the present invention with reference to the attached drawings.

FIG. 3 shows one instance of the direction of oscillation of an oscillation panel 3 with respect to a support device 2 in a body balance correcting apparatus 1 of the present invention. Referring to FIG. 3, the direction of an arrow which indicates reciprocation is the direction of oscillation of the oscillation panel 3, and shall be the axial direction of the body of a user. As far as the support device 2 is of a type capable of installation of a drive means, it may be possible also for the support device to take a thin panel form without being limited to a support base-like form. Alternatively, a hollow box-type support device having a reinforcing rib therein is available as well, for instance.

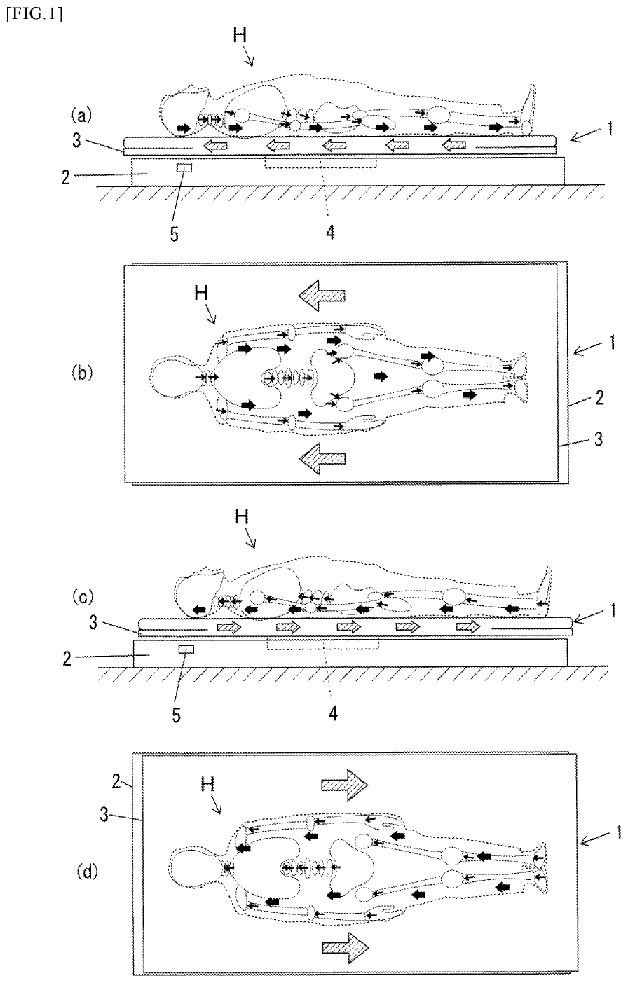

FIG. 1 is an explanatory view of a force generated inside the body of a user H when the oscillation panel 3 is subjected to oscillation, in regard to one embodiment of the body balance correcting apparatus of the present invention.

Referring to FIG. 1, a broken line part represented by a reference numeral 4 indicates a linear servo motor or like drive device as the drive means, and this embodiment assumes that the drive device should be interposed between an inner upper part of the support device 2 and a central part of a lower surface of the oscillation panel 3 to apply a drive force in the linear direction. Reference numeral 5 represents a controller equipped with a microcomputer as a control means.

The number of drive device 4 is not limited to one, and accordingly, a plurality of drive devices may be arranged in a decentralized manner to perform driving in synchronization with each other. Further, it may be possible also for the drive device to be installed between a side surface of the support device 2 and a peripheral edge of the oscillation panel 3, for instance.

The upper surface of the support device 2 and the lower surface of the oscillation panel 3 shall constitute a structure in which the oscillation panel is supported to the support device through a slide surface formed using a low frictional material or alternatively, through a plurality of rollers or ball rollers, for instance, thereby allowing the oscillation panel 3 to oscillate with a smaller drive force.

In regards to FIG. 1, FIG. 1(a) is a cross-sectional view showing the force generated inside the body of the user H when the oscillation panel 3 is accelerated in the left direction in FIG. 1(a), and FIG. 1(b) is a plan view corresponding to FIG. 1(a). FIG. 1(c) is a cross-sectional view showing the force generated inside the body of the user H when the oscillation panel 3 is accelerated in the right direction in FIG. 1(c), and FIG. 1(d) is a plan view corresponding to FIG. 1(c).

The oscillation panel 3 can be adjusted to oscillate at an amplitude A in the horizontal direction with respect to the support device 2 at least in a range of 0 to 6 cm and within 15 cm and with a cycle T at least in a range of 0.5 to 2.0 seconds, and hence, acceleration and deceleration of the oscillation of the oscillation panel 3 shall be adjusted in response to a control order from the controller 5.

An appropriate range for the amplitude A to be controlled by the controller 5 after start of the oscillation of the oscillation panel 3 is from about 2 to 6 cm, and an appropriate range for the cycle T to be controlled as described the above is from about 0.8 to 1.5 seconds. Application of the acceleration and deceleration of the oscillation or that of the rapid acceleration and rapid deceleration thereof in the above amplitude range and in the above cycle range allows the force or impact equivalent to the acceleration to be imparted to the whole body of the user, thereby resulting in relaxing the user mentally, while enabling amelioration of blood circulation, correction of skeleton and joint correction and consequently, correction of body balance over the wide range of the body of the user to be achieved by the interaction caused by the difference in constitution and/or form of the body tissues between the internal tissues of the whole body of the user including one's skeletal, muscular and blood circulatory systems.

In principle, the body balance correcting apparatus of the present invention makes use of a drive energy generated by the drive device 4 as a force for oscillation of the body of the user H through the oscillation panel 3, and is to enable amelioration of blood circulation, correction of skeleton and joint positions and consequently, correction of body balance to be achieved by the interaction caused by the difference in constitution and/or form of the body tissues between the internal tissues of the whole body of the user H including one's skeletal, muscular and blood circulatory systems during the time that the body of the user is being subjected to oscillation, unlike a conventional type of massaging apparatus which is to directly apply a force to the human body in the form of a massaging and/or pressing or stimulation-imparting force with an energy generated by the drive source.

Namely, the body balance correcting apparatus of the present invention shall allow the direction of even a force acting on blood flowing through blood vessel to be changed alternately during repetitive reciprocation of the oscillation panel 3, because the user H is laid in the recumbent position on the oscillation panel 3. The acceleration and deceleration of the oscillation inclusive of the rapid acceleration and rapid deceleration thereof are repeated during the time that the body of the user is being subjected to oscillation together with the oscillation panel 3, and accordingly, the blood circulation comes to be ameliorated even though there is a frictional force being generated between the inner wall of the blood vessel and the blood flow.

Likewise, in regards to the tissues of the skeletal and muscular systems and the like, the acceleration and deceleration of the oscillation are repeated so that a mutually massaging force shall be imparted during the time that the body of the user is being subjected to oscillation in a situation where the user is relaxed with one's body stretched in the recumbent position, and accordingly, an effect of body balance correction inclusive of the skeletal correction can be obtained.

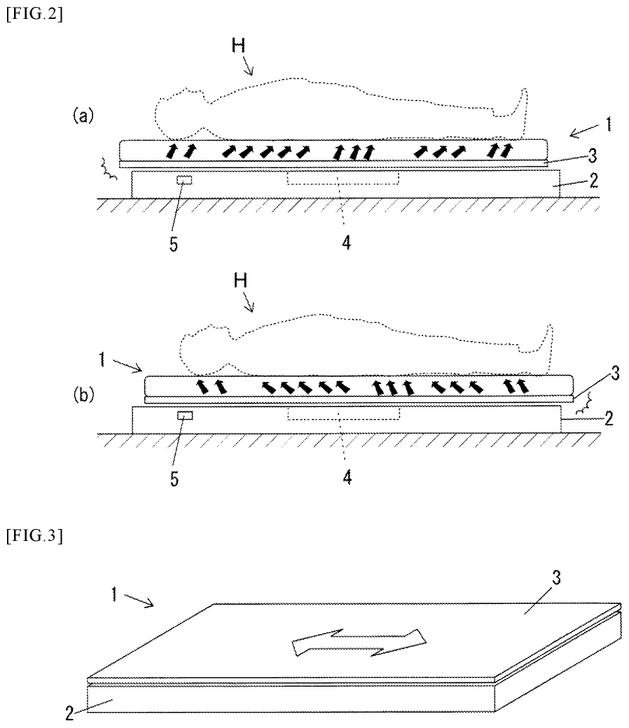

FIG. 2 is an explanatory view of a force applied to the body of the user through the oscillation panel 3 with the body balance correcting apparatus of the present invention, FIG. 2(a) being a cross-sectional view showing the direction of the force applied to the body through the oscillation panel 3 at the moment that the oscillation panel is decelerated on the left side in FIG. 2(a) so that the accelerating direction is reversed, and FIG. 2(b) being a cross-sectional view showing the direction of the force applied to the body through the oscillation panel 3 at the moment that the oscillation panel is decelerated on the right side in FIG. 2(a) so that the accelerating direction is reversed.

In addition to the function as described with reference to FIG. 1, according to the body balance correcting apparatus of the present invention, when the acceleration and deceleration of the oscillation are repeated during the time that the body of the user is being subjected to oscillation together with the oscillation panel 3 by the drive device 4, there is a frictional resistance force being imparted even in a position of contact between the oscillation panel 3 and the body part of the user H so that the user may have a sense of inertia force, in which case, however, the frictional resistance force in the position of contact therebetween at that time is allowed to act as a pressing force against the body part of the user, and accordingly, the massage effect can be obtained.

When the user H wants to get the massage effect on one's specific body part, it is possible for the user to obtain the massage effect on that specific body part by taking a posture in which the user presses one's specific body part against the oscillation panel 3, or alternatively, by using an exclusive pad and the like in accordance with the user's preference.

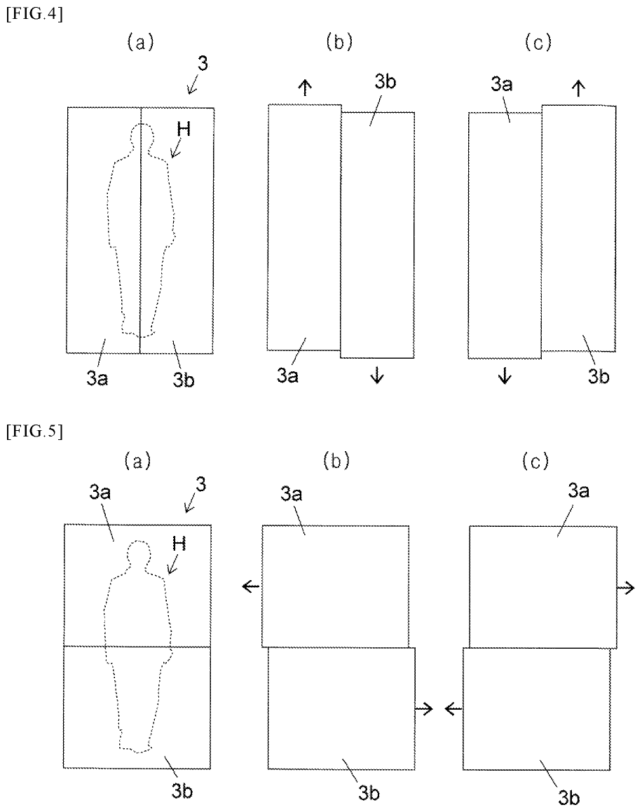

FIG. 4 planarly shows the oscillation panel 3 in the form of being divided into two, namely right and left oscillation panel units in the body direction of the user, as another embodiment of the body balance correcting apparatus of the present invention.

In contrast to the above configuration of the body balance correcting apparatus 1 comprising the oscillation panel 3 for supporting the user in the recumbent position, the support device 2 for supporting the oscillation panel 3 so as to enable the oscillation panel 3 to oscillate in the in-plane direction, the drive device 4 for oscillating the oscillation panel 3 with respect to the support device 2, and the controller 5 for controlling the oscillation caused by the drive device 4 as shown in FIG. 1, an embodiment shown in FIG. 4 is to provide the body balance correcting apparatus configured such that the oscillation panel 3 is in the form of being divided into the right and left oscillation panel units in the body direction of the user H.

In this case, when the directions of oscillation of the respective oscillation panel units 3a, 3b are controlled to be reversed to each other, a massage action can be imparted in the form of application of periodic twist between a right half and a left half of the body of the user. It is to be noted that it may be possible also for the right and left oscillation panel units 3a, 3b to oscillate in synchronization with each other in the same direction.

FIG. 5 planarly shows the oscillation panel 3 in the form of being divided into two, namely front and rear oscillation panel units in the body direction of the user, as still another embodiment of the body balance correcting apparatus of the present invention.

In this case, when the directions of oscillation of the respective oscillation panel units 3a, 3b are controlled to be reversed to each other, the massage action can be also imparted in the form of application of periodic twist between an upper half and a lower half of the body of the user. It is to be noted that it may be possible also for the oscillation panel units 3a, 3b to oscillate in synchronization with each other in the same direction.

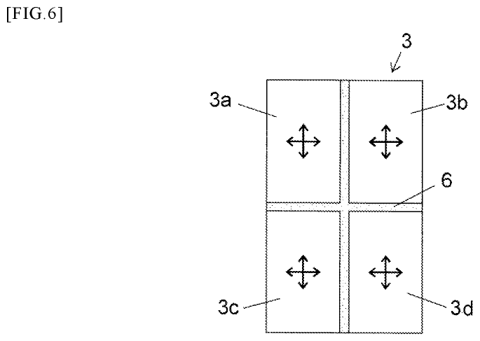

FIG. 6 planarly shows the oscillation panel in the form of being divided into four, namely the front, rear, right and left oscillation panel units, as still more another embodiment of the body balance correcting apparatus of the present invention.

In this case, for instance, when the left-sided front and rear oscillation panel units 3a, 3c are subjected to oscillation in synchronization with each other in the longitudinal direction, while the right-sided front and rear oscillation panel units 3b, 3d are subjected to oscillation in synchronization with each other in the direction opposite to the left-sided two oscillation panel units, the same motion as the oscillation panel 3 in the form of being divided into the right and left oscillation panel units can be obtained.

Likewise, when the front-sided right and left oscillation panel units 3a, 3b are subjected to oscillation in synchronization with each other in the horizontal direction, while the rear-sided right and left oscillation panel units 3c, 3d are subjected to oscillation in synchronization with each other in the direction opposite to the front-sided two oscillation panel units, the same motion as the oscillation panel 3 in the form of being divided into the front and rear oscillation panel units can be obtained.

Further, the four pieces of oscillation panel units 3a, 3b, 3c, 3d resulting from division of the oscillation panel 3 into the front, rear, right and left oscillation panel units can be controlled so as to make these oscillation panel units move independently of each other as well.

An elastic body 6 and the like capable of following each uncoordinated motion of the four pieces of oscillation panel units 3a, 3b, 3c, 3d resulting from division of the oscillation panel into the front, rear, right and left oscillation panel units can be interposed between these oscillation panel units so as to produce no clearance therebetween.

### EXPLANATION OF REFERENCE NUMERALS

H . . . User, 1 . . . Body balance correcting apparatus, 2 . . . Support device, 3 . . . Oscillation panel, 4 . . . Drive device, 5 . . . Controller, 3a, 3b, 3c, 3d . . . Oscillation panel unit, 6 . . . Elastic body

1. A body balance correcting apparatus comprising an oscillation panel for supporting a user in a recumbent position, a support device for supporting said oscillation panel so as to enable said oscillation panel to oscillate in the in-plane direction, a drive means for oscillating said oscillation panel with respect to said support device, and an oscillation control means for controlling oscillation caused by said drive means,
wherein said oscillation control means is equipped with an amplitude adjustment means capable of adjusting an amplitude A of the oscillation of said oscillation panel in the horizontal direction with respect to said support device at least in a range of 0 to 6 cm and within 15 cm, a cycle adjustment means capable of adjusting a cycle T of the oscillation of said oscillation panel at least in a range of 0.5 to 2.0 seconds, and an acceleration adjustment means for making adjustment of acceleration and deceleration of the oscillation of said oscillation panel, and
wherein the amplitude, cycle and repetition between acceleration and deceleration of the oscillation of said oscillation panel are controlled by said oscillation control means, thereby allowing a force equivalent to the acceleration from said drive means to act on the whole body of the user including one's skeletal, muscular and blood circulatory systems.

2. The body balance correcting apparatus according to claim 1, wherein a restraint means for suppressing the movement of the body of said user is provided on the upper surface side of said oscillation panel.

3. The body balance correcting apparatus according to claim 1, wherein said support device is provided with an upper load measurement means for making measurement of an upper load inclusive of a mass of said oscillation panel.

4. The body balance correcting apparatus according to claim 1, wherein said oscillation panel is divided into a plurality of oscillation panel units as seen from a plane, and a drive means is provided every oscillation panel unit to oscillate each respective oscillation panel unit with respect to said support device.

5. A body balance correcting method characterized by using a body balance correcting apparatus comprising an oscillation panel for supporting a user in a recumbent position, a support device for supporting said oscillation panel so as to enable said oscillation panel to oscillate in the in-plane direction, a drive means for oscillating said oscillation panel with respect to said support device, and an oscillation control means for controlling oscillation caused by said drive means, said oscillation control means being equipped with an amplitude adjustment means capable of adjusting an amplitude A of the oscillation of said oscillation panel in the horizontal direction with respect to said support device at least in a range of 0 to 6 cm and within 15 cm, a cycle adjustment means capable of adjusting a cycle T of the oscillation of said oscillation panel at least in a range of 0.5 to 2.0 seconds, and an acceleration adjustment means for making adjustment of acceleration and deceleration of the oscillation of said oscillation panel, wherein the amplitude, cycle and repetition between acceleration and deceleration of the oscillation of said oscillation panel are controlled by said oscillation control means, thereby allowing a force equivalent to the acceleration from said drive means to act on the whole body of the user including one's skeletal, muscular and blood circulatory systems.

6. The body balance correcting method according to claim 5, wherein said oscillation control means controls said oscillation panel to oscillate at an amplitude in a range of 2 to 6 cm and with a cycle in a range of 0.8 to 1.5 seconds.

7. A body balance correcting apparatus comprising an oscillation panel for supporting a user in a recumbent position, a support device for supporting said oscillation panel so as to enable said oscillation panel to oscillate in the in-plane direction, a drive means for oscillating said oscillation panel with respect to said support device, and an oscillation control means for controlling oscillation caused by said drive means, said oscillation panel being divided into a plurality of oscillation panel units as seen from a plane, and the drive means being provided every oscillation panel unit to oscillate each respective oscillation panel unit with respect to said support device,
wherein said oscillation control means is equipped with an amplitude adjustment means capable of adjusting an amplitude A of the oscillation of said each respective oscillation panel unit in the horizontal direction with respect to said support device, a cycle adjustment means capable of adjusting a cycle T of the oscillation of said each respective oscillation panel unit, and an acceleration adjustment means for making adjustment of acceleration of the oscillation of said each respective oscillation panel unit, and
wherein the amplitude, cycle and repetition between acceleration and deceleration of the oscillation of said each respective oscillation panel unit are controlled by said oscillation control means, thereby allowing a force equivalent to the acceleration from said drive means corresponding to said each respective oscillation panel unit to act on the whole body of the user including one's skeletal, muscular and blood circulatory systems.

8. A body balance correcting method characterized by using a body balance correcting apparatus comprising an oscillation panel for supporting a user in a recumbent position, a support device for supporting said oscillation panel so as to enable said oscillation panel to oscillate in the in-plane direction, a drive means for oscillating said oscillation panel with respect to said support device, and an oscillation control means for controlling oscillation caused by said drive means, said oscillation panel being divided into a plurality of oscillation panel units as seen from a plane, the drive means being provided every oscillation panel unit to oscillate each respective oscillation panel unit with respect to said support device, said oscillation control means being equipped with an amplitude adjustment means capable of adjusting an amplitude A of the oscillation of said each respective oscillation panel unit in the horizontal direction with respect to said support device, a cycle adjustment means capable of adjusting a cycle T of the oscillation of said each respective oscillation panel unit, and an acceleration adjustment means for making adjustment of acceleration and deceleration of the oscillation of said each respective oscillation panel unit, wherein the amplitude, cycle and repetition between acceleration and deceleration of the oscillation of said each respective oscillation panel unit are controlled by said oscillation control means, thereby allowing a force equivalent to the acceleration from said drive means corresponding to said each respective oscillation panel unit to act on the whole body of the user including one's skeletal, muscular and blood circulatory systems.

9. The body balance correcting method according to claim 8, wherein at least part of the mutually adjacent oscillation panel units is subjected to oscillation in the opposite direction.

10. The body balance correcting method according to claim 8, wherein said oscillation control means controls said each respective oscillation panel unit to oscillate at an amplitude in a range of 0 to 6 cm and with a cycle in a range of 0 to 1.5 seconds.
